(19) United States
(12) Patent Application Publication
(10) Pub. No.: US 2023/0094378 A1
(43) Pub. Date: Mar. 30, 2023

(54) METHOD FOR PRODUCING A HIGH-PRESSURE TREATED PLANT SEED BASE PRODUCT, AND PLANT SEED BASE PRODUCT

(71) Applicant: Döhler GmbH, Darmstadt (DE)

(72) Inventors: Mike RICHTER, Darmstadt (DE); Astrid SCHÖNBERGER, Darmstadt (DE); Daniel BONERZ, Bensheim (DE); Julian ASCHOFF, Griesheim (DE)

(73) Assignee: Döhler GmbH, Darmstadt (DE)

(21) Appl. No.: 17/792,169

(22) PCT Filed: Jan. 11, 2021
(86) PCT No.: PCT/EP2021/050336

§ 371 Date: Jul. 12, 2022

(30) Foreign Application Priority Data
Jan. 14, 2020 (EP) PCT/EP2020/050767

(51) Int. Cl. A23C 11/10; A23L 7/104

(52) U.S. Cl. CPC A23C 11/106; A23L 7/107; A23V 2002/00

(57) ABSTRACT

A method provides a base for milk substitute products from plant seeds which gives a smooth mouthfeel similar to that of the corresponding product from animal milk. The method comprises the steps of: a) soaking plant seed feedstock in water, and b) high-pressure homogenizing of the liquefied plant seed feedstock at a pressure of at least 800 bar, preferably at least 1000 bar, most preferably at least 2000 bar.

### TECHNICAL FIELD

The disclosure relates to a method for producing a plant seed base product and to a plant seed base product.

### BACKGROUND

Plant-based milk substitute products are becoming increasingly important for modern nutrition. These are products which, in terms of taste and application properties, come as close as possible to products based on animal milk, in particular cow's milk, but do not contain any components of animal origin. Such products are in demand by people who are allergic to lactose or milk protein as well as by people who eat vegetarian or vegan food.

Therefore, plant-based products have been developed, so-called “dairy alternatives” or milk substitute products. One possible starting product for plant-based milk substitute products are seeds (in German: “Samen”), especially cereals and other plant seeds (in German: “Saaten”). “Seeds” are tissue structures of seed plants, consisting of a seed coat, the embryo, and in some seed plants a nutritive tissue, the endosperm or perisperm.

“Cereal” or “grain” refers to the fruits of sweet grasses that are used for human and animal nutrition. These fruits are composed of the starchy endosperm, the embryo, and the seed coat made up of the skin and pericarp and the aleurone layer sandwiched between the starchy endosperm and the skin. Grains include, for example, wheat, rye, oats, barley, triticale which is a hybrid of wheat and rye, corn, rice, millet, and bamboo seeds. The endosperm contains mainly starch. The embryo contains fat, and the aleurone layer contains protein, while the endosperm also contains some percentage of protein.

After the harvest, the grain fruits are separated from the mown plants by threshing, while the awns and husks that have grown together with the seed coat will still remain on the grain in some varieties. When processing the threshed grain into flour, the seed coat is often removed as completely as possible and separated as bran.

“Wholegrain” refers to cereal fruits in which only the awns and husks have been removed after harvesting, i.e. which still completely contain the seed coat.

In the context of the present application, the term “wholegrain” shall refer to whole, ground, comminuted, or flaked grains after the non-edible parts such as husks and pods have been removed, in compliance with the European wholegrain definition developed as part of the EU research project “HEALTHGRAIN”. The main components of the anatomical structure of a cereal grain, namely the starchy endosperm, the embryo and the seed coat, are included in the “wholegrain” in the same proportion as in the original whole grain. Wholegrain can be broken down into fragments of different sizes, resulting in grist, groats, or flour. Another variant made from whole grains by mechanical processing are flakes. Grist, groats, flour, or flakes can also be provided from other plant seeds (in German: “Saaten”).

From a nutritional point of view, the use of the entire components of seeds, especially of wholegrains or whole seeds, is desirable for milk substitute products, since components of wholegrains such as antioxidants, fibers, and secondary plant substances with anti-inflammatory effects are associated with a positive effect on humans.

WO 00/65930 describes a process in which oat bran or whole grain oat flakes are suspended in water up to a dry mass content of 1% to 35%, and the obtained suspension is heat-treated at 50° C. to 95° C. for 10 to 60 minutes. This is followed by wet-grinding and mechanical homogenization at a temperature of 50° C. to 95° C. and at a pressure in the range from 80 to 250 bar to obtain a cream-like emulsion.

### SUMMARY

It has been found that the bran leads to a rough mouthfeel in milk substitute products. This means that milk substitute products with the nutritional benefits of whole grains are not accepted by consumers.

Therefore, a resulting object of the invention is to provide a plant base for milk substitute products, which provides a smooth mouthfeel similar to that of the corresponding product made from animal milk. Furthermore, it is an object of the invention to create a product that contains as many components as possible of the whole seed, in particular of the whole grain.

The invention achieves these objects in a surprisingly simple manner by a method as claimed and with a wholegrain base product as claimed.

The invention provides a method for producing a plant seed base product, comprising the steps of:
a) soaking plant seed feedstock in water, the plant seed feedstock comprising at least seeds selected from the group consisting of cereals, pseudocereals, other plant seeds, and mixtures of these seeds;
b) high-pressure homogenizing of the plant seed feedstock which has been liquefied, in particular by the soaking, at a pressure of at least 800 bar, preferably at least 1000 bar, most preferably at least 2000 bar,
   without removing any components of the seeds used.

Within the scope of the invention, the plant seed feedstock can be provided in the form of flour, grist, groats and/or flakes. Furthermore within the scope of the invention, a combination of chemically and/or enzymatically treated starch with seed coats and/or bran can be used as the plant seed feedstock. A further possibility of providing the plant seed material within the scope of the invention is the use of whole grains.

In an advantageous embodiment of the method, step b) is preceded by a step
b1) of liquefying the mixture from step a) in order to produce a liquefied plant seed feedstock.

The liquefying, or liquefaction, is achieved under the action of enzymes on the plant seed feedstock. Depending on the type of plant seed feedstock used, the intrinsic enzymes of the feedstock will be sufficient for this purpose. It comes also within the scope of the invention to add enzymes, as will be explained further below. Liquefaction takes place after the enzymes have been allowed to take effect for a certain time. The total dietary fiber content will be reduced thereby by at least 5%, preferably by at least 7%, most preferably by at least 10%, compared to the seed feedstock. In an advantageous embodiment, heating is performed at the beginning, in order to gelatinize (any) existing starch and make it more accessible for the enzymes.

Depending on the feedstock that is employed, the high-pressure homogenization can thus be performed more easily, since the liquefaction enables to lower the viscosity and/or improve the homogeneity of the fluid fed to the high-pressure homogenization process.

The inventive high-pressure homogenization of the plant seed feedstock, in particular the liquefied one, produces a high-pressure treated plant seed base product. This provides for a wide range of applications, in particular as a substitute for milk products such as drinking milk, drinking yoghurt, and yoghurt.

Thus, by a one-step process, the invention provides a plant seed base product based solely on seeds and water, which can include all components provided by the seeds that are employed, or by their degradation products. These components, i.e. starch, fats, or proteins may have been at least partially broken down. In this way, the product properties such as mouthfeel, taste and/or flow behavior of the plant seed base product are adjusted within the context of the invention.

However, no components of the employed seed are removed in a preferred embodiment of the invention, for example by separating them through centrifugation of seed coat components, or by detaching and then discarding them. By using the soaking water as a product component, the invention ensures that all water-soluble components of the entire seed, which dissolve during soaking, remain in the product. Also, the invention does not require the addition of stabilizing auxiliaries.

Liquefaction is accompanied by the breakdown of starch molecules, and the viscosity is reduced compared to the mash.

In an advantageous embodiment of the method according to the invention, step a) is preceded by a step
a1) of adding at least one enzyme, in particular at least one amylase and/or at least one lipase and/or at least one β-glucanase and/or at least one protease and/or at least one cellulase.

The adding of enzymes enables to break down individual components of the plant seed feedstock in order to selectively modify the composition of the product on the basis of the components of the seed. For example, the included starch can be at least partially broken down into sugar in order to produce flavor and/or texture. In particular in the case of some oilseeds, the use of at least one cellulase is helpful for this purpose.

In an advantageous embodiment of the invention, at least one enzyme is acting, which has a hydrolytic activity towards dietary fibers, preferably a hydrolytic activity of at least 5%, more preferably a hydrolytic activity of at least 7%, and most preferably a hydrolytic activity of at least 10%. This can be at least one enzyme native to the seed, which starts acting in conjunction with the soaking, and/or at least one enzyme that is added.

In a further embodiment of the method according to the invention, the pH value can be adjusted, for example to values in the range from pH 4 to pH 9, in particular by adding an acid or a lye, in order to optimize the enzyme treatment in the context of step a1).

When the action of the enzymes and/or a negative impact thereof, such as on the taste and/or the flow properties, is to be prevented, it is contemplated according to a further embodiment of the method according to the invention, that step b) is preceded by a step
b2) of deactivating at least one enzyme which is in particular selected from the group consisting of amylases, lipases, β-glucanases, cellulases, and proteases.
   The sequence of steps b1) and b2) prior to step b) can be chosen appropriately by a person skilled in the art depending on the circumstances of the specific application.

In a further embodiment, the invention provides two options for the deactivating of at least one enzyme, which options can be combined, namely heating and/or altering the pH value. In particular if the addition of acid and/or lye to the product is undesirable, the deactivation can be achieved simply by heating. If high temperatures are to be avoided as far as possible over a longer period of time, at least one enzyme can be deactivated by acidification and subsequent neutralization.

Within the scope of the invention, the deactivation is possible in a wide temperature range and over different time durations, so that further process parameters are provided for adapting the method to the respective application case. The deactivating can be performed at temperatures in a range up to 150° C., for example by purely thermal deactivation at temperatures in the range between 120° C. and 150° C., and/or at a maximum temperature of 100° C., preferably at a maximum temperature of 95° C., and in particular over a duration of up to one hour, preferably over a duration of up to 30 minutes, more preferably of up to 10 minutes, most preferably of up to 5 minutes.

For a deactivation by altering the pH in particular prior to the heating, the pH can be adjusted within the scope of the invention so as to be in the range from 3 to 5, preferably in the range from 3.5 to 4.5, most preferably in the range from 3.9 to 4.1.

For a deactivation by altering the pH in particular following the heating, the pH can be adjusted within the scope of the invention so as to be in the range from 6 to 8, preferably in the range from 6.5 to 7.1, most preferably in the range from 6.7 to 7.

According to an advantageous embodiment of the method according to the invention it is contemplated that step b) is preceded by a step
b11) of comminuting the plant seed feedstock; and/or by a step
b111) of comminuting the liquefied plant seed feedstock.

The comminuting according to step b11) and/or step b111) can be performed by using a rotor-stator dispersing device, for example, in particular a cutting mill. A “Turrax” used inline has proven to be particularly suitable in a simple manner. Comminuting is also possible through a high-pressure treatment which is performed at significantly lower pressures than the actual high-pressure homogenization, for example at pressures of up to 300 bar.

The comminuting according to step b111) can be performed in addition to or as an alternative to the optional comminuting according to step b11). Especially when using flakes as a plant seed or seed feedstock, the optional comminution is helpful in the method according to the invention, in particular in order to be able to adjust the flowability of the (liquefied) feedstock to the respective requirements of the process.

The invention moreover offers the possibility, within the scope of the method, of making durable, i.e. increasing the shelf-life, of the high-pressure treated plant seed base product. For this purpose it is contemplated that step b) is followed by a step
c) of keeping hot the high-pressure treated plant seed base product,
   in particular at a temperature in the range from 60° C. to 140° C., preferably in the range from 65° C. to 95° C., most preferably at a temperature of 70° C.,
   and in particular over a duration of up to 50 minutes, preferably over a duration of up to 20 minutes to 40 minutes, yet more preferably over a duration of up to 45 seconds, yet more preferably over a duration of up to 10 seconds, yet more preferably over a duration of up to 5 seconds, most preferably of up to 4.6 seconds.

A person skilled in the art will choose the parameters of temperature and holding time in coordination with one another. For example, at a temperature in the range from 130° C. to 140° C., holding times of a few seconds will be sufficient to achieve sterilization. At lower temperatures, longer holding times are used. At some point, the temperature is so low that sterilization is no longer possible, only pasteurization. For example, 95° C. over 45 seconds only allows for pasteurization. At 65° C., adequate pasteurization can be achieved with holding times ranging from about 20 to about 40 minutes.

The invention furthermore provides a plant seed base product which is in particular produced by a method as described above, and which comprises essentially all components of at least one plant seed, in particular a wholegrain cereal, with a volume density distribution of the particles of the plant seed base product in which d_{3.97} is not more than 130 micrometers, preferably not more than 120 micrometers.

The plant seed base product according to the invention has been homogenized using high-pressure, in particular by what is known as “ultra-high pressure”. What is achieved thereby according to the invention is that a proportion of 97% of the volume of the particles included in the plant seed base product is occupied by particles which are smaller than 130 micrometers, preferably smaller than 120 micrometers. Otherwise stated, only 3% by volume of the particles included in the plant seed base product are larger than 120 micrometers within the scope of the invention. Thus, the invention advantageously provides a plant seed base product with a smooth mouthfeel and thus allows to overcome the drawback of known products having a rough mouthfeel.

In a further embodiment of the invention, the plant seed base product of the invention can include a percentage of plant seeds in the plant seed base product of up to 60 wt. %, preferably up to 50 wt. %, more preferably up to 35 wt. %, yet more preferably up to 20 wt. %, most preferably up to 15 wt. %. With the choice of the percentage of plant seeds over a wide range, the invention offers a possibility to selectively adjust the taste, texture, and/or mouthfeel of the base product, or the flow properties thereof, depending on the cereals and/or seeds used for the plant seed feedstock and/or depending on the intended use of the base product.

The inventors are not aware of any fundamental restrictions regarding the feedstock for the plant seed base product according to the invention, so that in principle any type of seed can be used within the scope of the invention, in particular any cereals and/or any pseudocereals and/or any other plant seeds, for example oilseeds. Mixtures of different seeds can also be used. For example, it is envisaged that the plant seed base product comprises at least seeds selected from the group consisting of cereals, in particular wheat, rye, oats, barley, triticale, corn, rice, millet, and bamboo, pseudocereals, in particular buckwheat, quinoa, chia, and amaranth, and other plant seeds such as in particular oilseeds and legume seeds, and mixtures of these seeds.

By selecting and combining the seeds it is possible, for example, to adapt the nutrient profile and/or the taste of the plant seed base product according to the invention to the respective requirements of the application.

The invention thus also enables to use a plant seed base product produced according to a method as described above as a foodstuff or as an additive to a foodstuff, in particular selected from the group consisting of alternatives to milk and milk products, beverages, drinking milk, milkshakes, drinking yoghurt, yoghurt, and ice cream preparations.

### BRIEF DESCRIPTION OF THE DRAWINGS

The invention will now be explained in more detail by way of exemplary embodiments and with reference to the accompanying figures, wherein:

FIG. 1 is a flow chart of a method for producing a plant seed base product according to a first embodiment of the invention;

FIG. 2 is a flow chart of a further embodiment of the method shown in FIG. 1 for producing a plant seed base product;

FIG. 3 is a flow diagram of a further embodiment of the method for producing a plant seed base product, including enzyme deactivation by altering the pH value and heating prior to high-pressure homogenization;

FIG. 4 is a flow chart of a further embodiment of the method for producing a plant seed base product, including enzyme deactivation by heating prior to high-pressure homogenization;

FIG. 5 is a flow chart of a further embodiment of the method for producing a plant seed base product, including comminution of the plant seed feedstock and/or of the liquefied plant seed feedstock;

FIG. 6 is a flow chart of a further embodiment of the method for producing a plant seed base product, including shelf-life enhancement of the plant seed base product by keeping it hot;

FIG. 7 is a flow chart of a further embodiment of the method for producing a plant seed base product, including shelf-life enhancement of the plant seed base product in a further embodiment of the invention;

FIG. 8 shows photographs of samples of a wholegrain oat base material with a dry mass content of 15 wt. % after ultra-high-pressure treatment at different pressures; and

FIG. 9 shows photographs of samples of a wholegrain oat base material with a dry mass content of 15 wt. % after ultra-high-pressure treatment at different pressures and refrigerated short-term storage.

### DETAILED DESCRIPTION

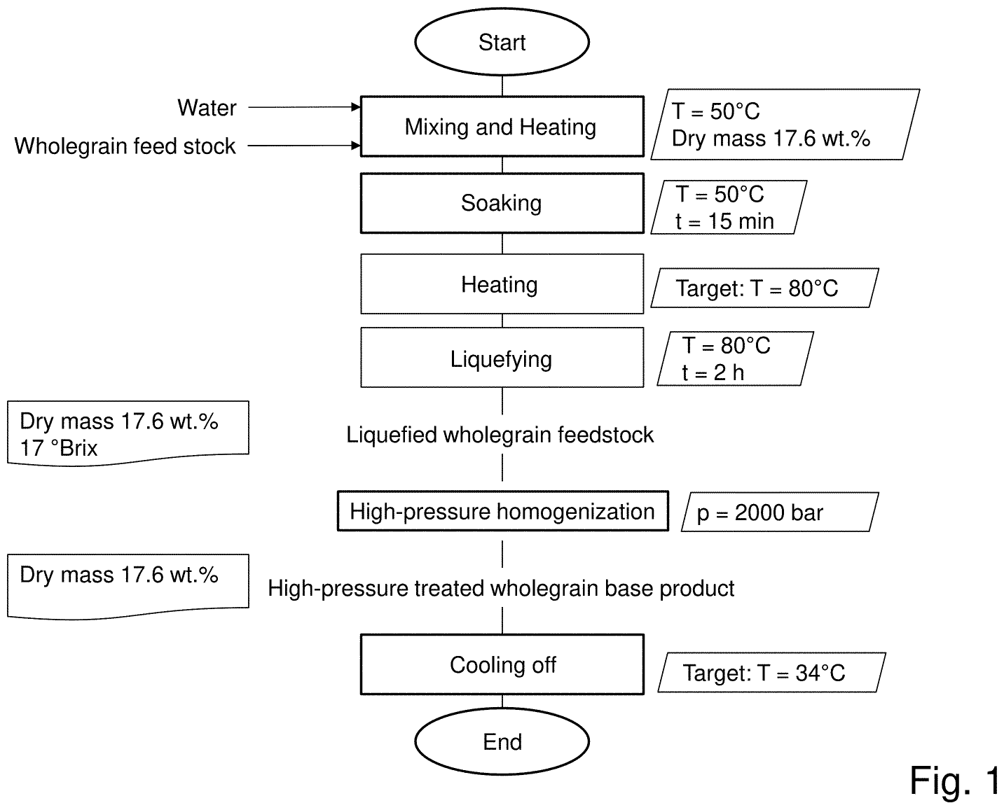

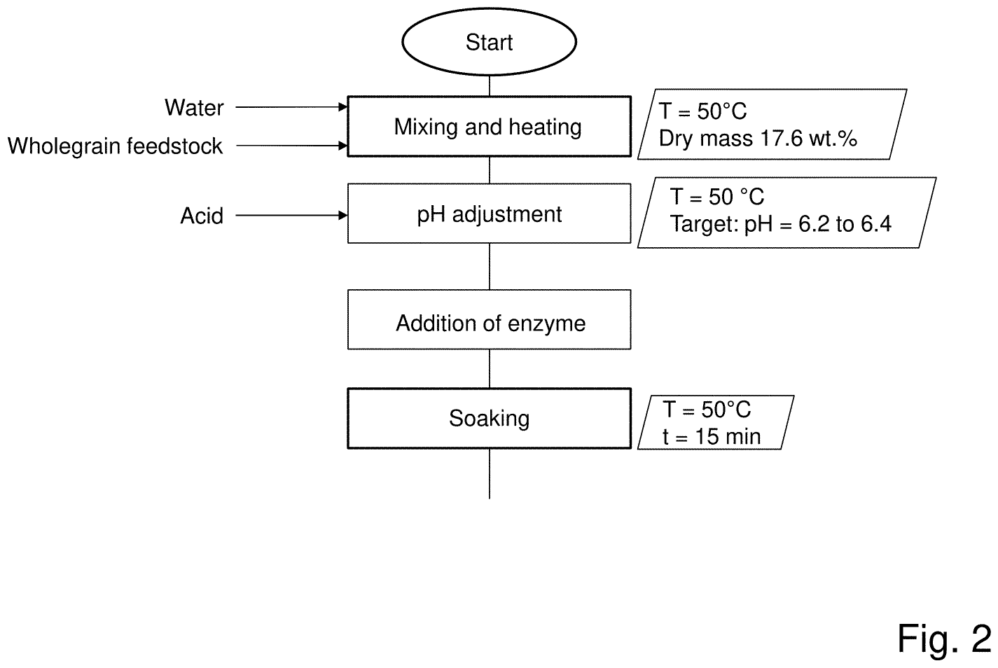

FIG. 1 shows a basic scheme of the method according to the invention for producing a plant seed base product, illustrated with the refinement of heating the feedstock mixture to produce a liquefied plant seed feedstock prior to the high-pressure homogenization. This heating for liquefying is an optional step of the method according to the present invention. FIGS. 2 to 7 illustrate refinements of the method shown in FIG. 1. These refinements can be integrated in the method shown in FIG. 1, individually or in combination with one another or all together.

In the accompanying figures, the stated method steps according to the basic scheme are framed by thicker lines than the method steps according to the refinements.

According to the basic scheme of the method according to the invention as shown in FIG. 1, water and plant seed feedstock are provided and mixed together while being heated. The mixing is done to make a mash. This step can also be referred to as mashing. In the illustrated embodiment, four parts of water were mixed with one part of plant seed feedstock. In the simplest case, the mixing can be executed by stirring in a kettle. In the illustrated exemplary embodiment, oat flour is used as the plant seed feedstock. Additionally or alternatively, oat flakes can be used within the scope of the invention. Other ways of providing the plant seed material within the scope of the invention include the use of whole grains and other cereal flours and/or flakes and the use of a combination of chemically and/or enzymatically treated starch with seed coat and/or bran. Depending on the feedstock available and depending on the specific application purpose, a person skilled in the art will be able to select or combine the plant seed feedstock to be employed.

In the illustrated exemplary embodiment, the mash has a dry mass content of 17.6 wt. % and is heated to a temperature of 50° C.

After heating, soaking of the plant seed feedstock in water begins. The plant seed feedstock will swell for a holding time as selected by a person skilled in the art, and will thereby absorb water.

In the exemplary embodiment as illustrated in FIG. 1, the soaking is followed by heating the swollen plant seed feedstock to a temperature of 80° C. and keeping it at this temperature over a duration of two hours thereby liquefying it. The plant seed feedstock liquefies as a result of the action of the enzymes that are intrinsic to the plant seed feedstock and/or are added according to one embodiment of the invention. Such refinements will be discussed in more detail below. The temperature and the holding time for liquefaction can be variably adjusted for the high-pressure homogenization, depending on the plant seed feedstock and in particular on the intended flow behavior.

The method step referred to as “liquefying” converts the mash into a homogeneous, flowable, in particular pumpable fluid. What is provided is a suspension of water-insoluble plant seed components in an aqueous phase which in particular contains proteins, starch, and sugars. These components are included in dissolved form, at least in part.

In order to ensure that the native starch molecules have been adequately degraded to sufficiently reduce the viscosity of the liquefied plant seed feedstock prior to the high-pressure homogenization, an iodine solution starch test can be performed on a sample of the product prior to entering the high-pressure homogenization.

The liquefied plant seed feedstock has a specific gravity of 17° Brix. It is conveyed through a nozzle, using at least one high-pressure pump, whereby the liquefied plant seed feedstock according to the invention is subjected to a significantly higher pressure load in comparison to conventional high-pressure homogenizers. Therefore, within the scope of the inventive method, the high-pressure homogenization is also referred to as “ultra-high-pressure homogenization” (UHPH for short). In the illustrated exemplary embodiment, the pressure is 2000 bar. The high-pressure homogenization produces the plant seed base product according to the invention from the liquefied plant seed feedstock. According to the exemplary embodiment illustrated in FIG. 1, this is followed by cooling off to a target temperature of 34° C.

For example, in order to adjust the flow behavior of the plant seed feedstock and of the liquefied plant seed feedstock, a further embodiment of the invention offers the possibility of influencing the composition of the plant seed feedstock in an enzymatic way. FIG. 2 schematically illustrates one implementation of this embodiment.

The pH is adjusted by adding acid, for example hydrochloric acid HCl, to obtain a pH value in a target range between 6.2 and 6.4. Subsequently, at least one enzyme is added. In the illustrated exemplary embodiment, a β-glucanase was used in a concentration of about 0.5 kg/MT of plant seed feedstock. This concentration has proven to be suitable when using oat flour. Furthermore, an alpha-amylase was added in the illustrated exemplary embodiment. For this enzyme, a concentration of about 1.0 kg/MT plant seed feedstock has proven to be suitable when using oat flour. The unit “MT” means “metric ton” (1000 kg), the specified values indicate the amount of enzyme used in kg per 1000 kg of seed feedstock.

In order to determine the hydrolytic activity of the employed enzyme, an oat flour was diluted with water, the enzyme was added and the mixture was wet-milled. The oat flour had a residual moisture content of 5%. Mixing it with water creates the “starting product” for the rest of the process, which has a moisture content of 62.79%.

In each case, the long-chain and short-chain dietary fiber fractions were determined. The sum of these fractions gives the total content of dietary fibers. For better comparability, these values were only related to the dry mass (residual moisture content of 0%), and a difference between the flour and the product was calculated for the individual fractions.

In the table given below, the abbreviation “HMWDF” stands for “high molecular weight dietary fiber” and “LMWDF” stands for “low molecular weight dietary fiber”.

The percentages or fractions of dietary fibers are given in g/100 g.

| | | Starting | | Starting | Differ- |
|---|---|---|---|---|---|
| | Oat flour | product | Oat flour | product | ence |
| Residual | 5% | 62.79% | 0% | 0% | |
| moisture | | | | | |
| Dietary | 13.37 ± 1.97 | 4.68 ± 0.96 | 14.07 ± 2.07 | 12.58 ± 2.58 | −11% |
| fibers | | | | | |
| HMWDF | 12.14 ± 1.85 | 3.24 ± 0.74 | 12.78 ± 1.95 | 8.71 ± 1.99 | −32% |
| content | | | | | |
| thereof | | | | | |
| LMWDF | 1.23 ± 0.38 | 1.44 ± 0.42 | 1.29 ± 0.40 | 3.87 ± 1.13 | 200% |
| content | | | | | |
| thereof | | | | | |

It is clearly apparent that the dietary fibers are affected. On the one hand, the total content of dietary fibers in the examined oat flour example drops by 11% compared to the raw material. Furthermore, a clear shift can be seen from the fraction of long-chain dietary fibers (HMWDF) to the fraction of smaller dietary fibers (LMWDF). Hence, the native dietary fibers are affected or attacked by the hydrolytic activity of the enzymes.

The results suggest that very large β-glucan molecules are broken down into medium-sized pieces.

Within the context of the invention, independently of the exemplary embodiment explained above, and similarly to the β-glucans found in oats and barley, the advantage of the hydrolytic breakdown of dietary fibers also applies to other soluble dietary fibers that increase the viscosity of a mixture made up of seed feedstock and water, such as to pentosans in rye or mucilage in linseed.

By breaking down these dietary fibers, the viscosity of the mixture of seed feedstock and water is greatly reduced, thereby allowing for a higher mixing ratio of seed feedstock to water, e.g. flour to water, by virtue of the invention. At the same time, the effort involved in pumping the mass is reduced, and better processability is generally facilitated.

Furthermore, water-soluble dietary fibers such as β-glucans are often associated with a “slimy” mouthfeel, hence their breakdown can improve the sensory impression.

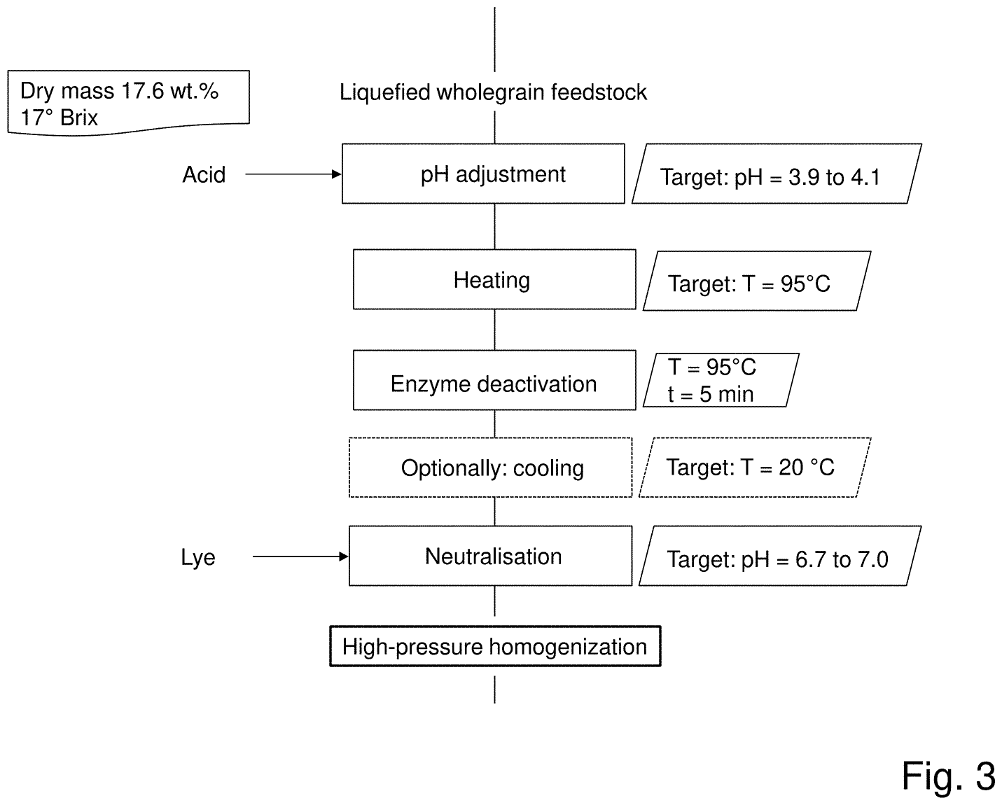

FIG. 3 schematically illustrates one option for deactivating the enzymes prior to high-pressure homogenization by altering the pH and heating. Deactivation is not absolutely need within the context of the invention. In the illustrated exemplary embodiment, the pH is initially adjusted by adding acid, for example hydrochloric acid HCl, to obtain a pH value in the target range of 3.9 to 4.1.

Then, the acidified liquefied plant seed feedstock is heated to a temperature of 95° C. and maintained at this temperature for a duration of 5 minutes. Optionally, the acidified plant seed feedstock can be cooled off to a temperature of 20° C. after the holding time, for example in order to reduce the stress on components of the employed apparatus, such as seals.

Prior to high-pressure homogenization, the pH value is neutralized by adding a lye, for example sodium hydroxide solution NaOH, to obtain a pH value in the target range of 6.7 to 7.0.

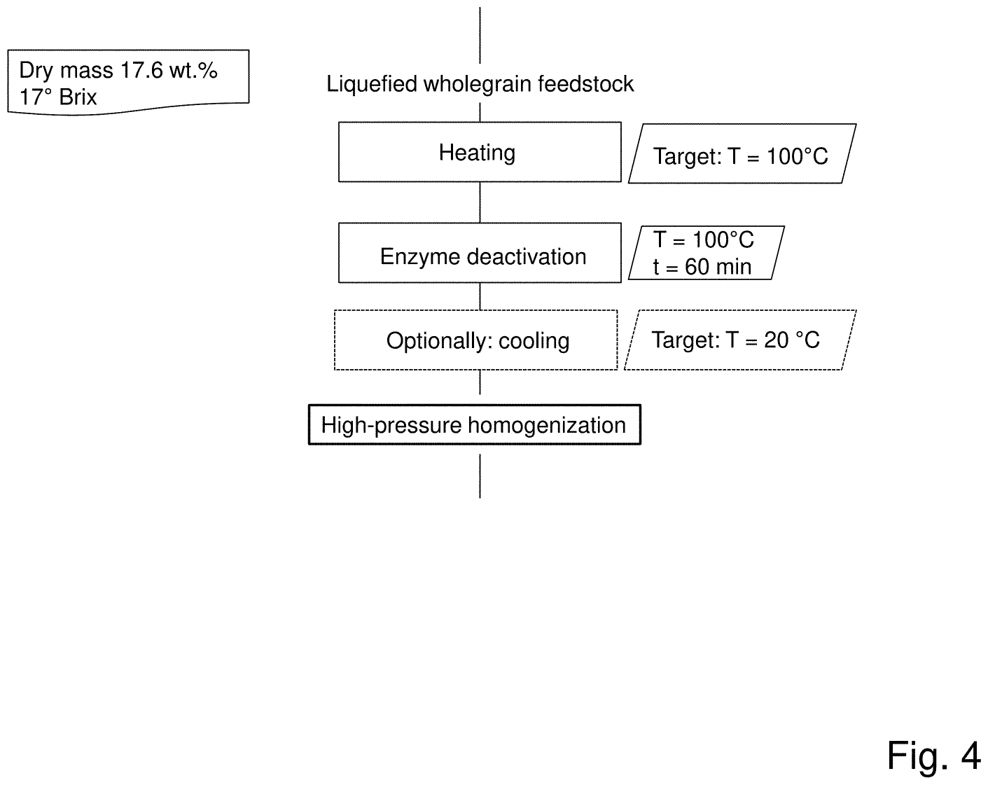

FIG. 4 schematically illustrates a further possibility for deactivating the enzymes. Here, the liquefied plant seed feedstock is heated to a target temperature of 100° C. and is kept at this temperature for a duration of 60 minutes. Optionally, the liquefied plant seed feedstock can be cooled off to a temperature of 20° C. after this holding time, for example in order to reduce the stress on components of the employed apparatus, such as seals.

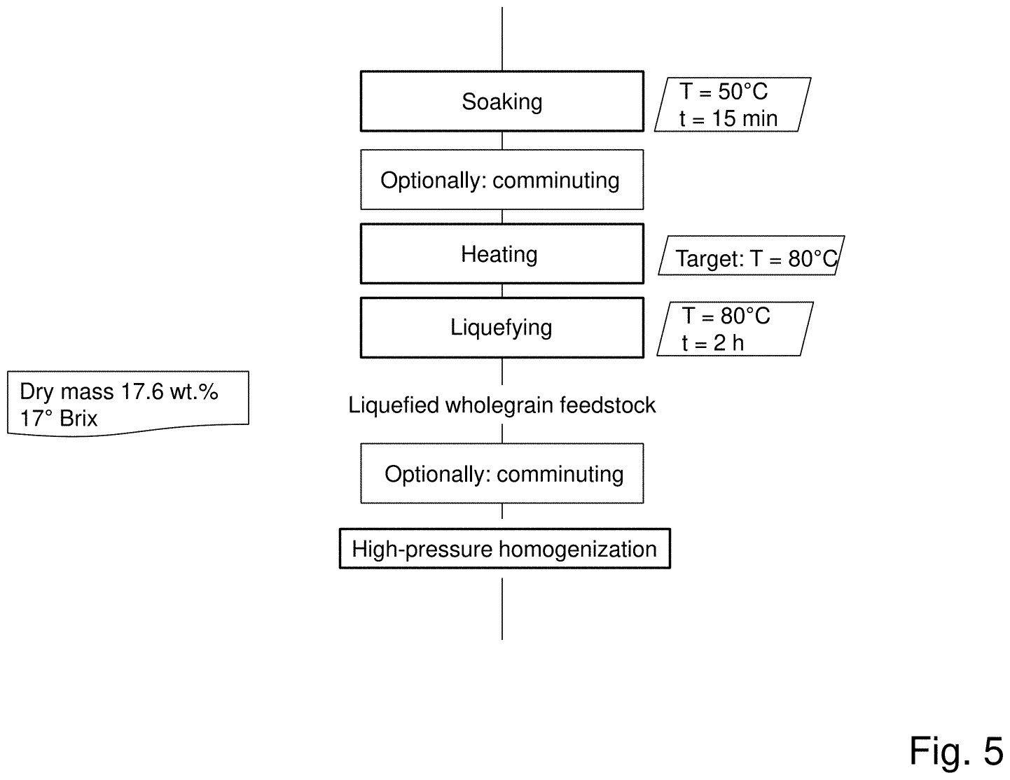

FIG. 5 schematically illustrates a further embodiment of the method, involving comminution of the plant seed feedstock and/or of the liquefied plant seed feedstock. Such comminution can have a positive effect on the particle size distribution achievable by the high-pressure homogenization, on the flow behavior of the product and/or on its composition, by breaking down the components of the plant seed feedstock and/or of the liquefied plant seed feedstock.

Thus, a comminution step can optionally be performed after the soaking. For example, such comminution can be achieved using a rotor-stator dispersing device, in particular a cutting mill. A “Turrax” used inline has proven to be particularly useful in a simple manner. Within the scope of the invention, comminuting is also possible through a high-pressure treatment which is performed at significantly lower pressures than the actual high-pressure homogenization, for example at pressures of up to 300 bar.

The high-pressure homogenization can be preceded by a comminution process as described above, which can be carried out in addition to or as an alternative to the optional comminution described above. Especially when using flakes or whole grains as the plant seed feedstock, the optional comminution will be helpful in the inventive method in order to be able to adapt the flowability of the (liquefied) plant seed feedstock to the respective requirements of the process.

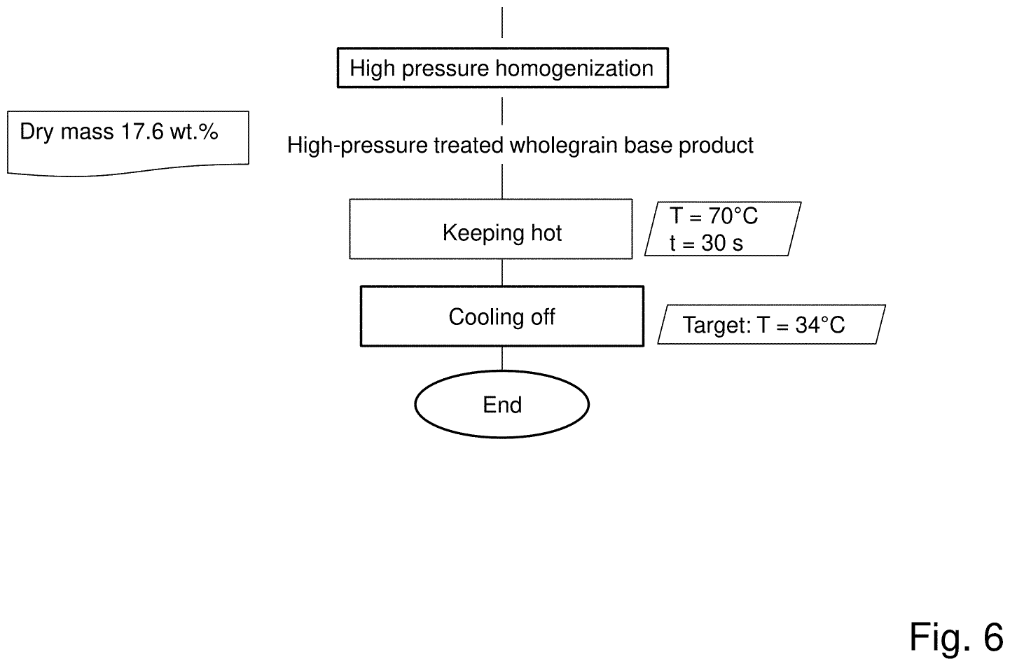

FIG. 6 schematically illustrates a further embodiment of the method intended for extending the shelf-life of the plant seed base product by killing microorganisms by keeping it hot. For this purpose, the high-pressure treated plant seed base product is kept at a temperature of 70° C. over a duration of 30 seconds.

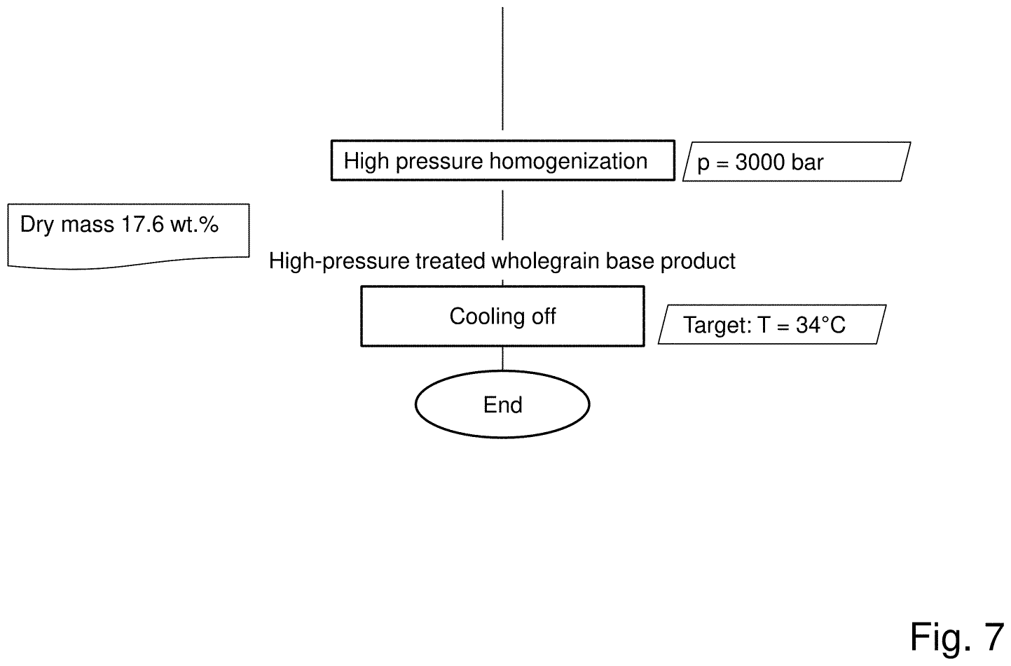

FIG. 7 schematically illustrates a further embodiment of the invention, which also results in an increase of the shelf life of the plant seed base product. The high-pressure homogenization is carried out at 3000 bar with an initial temperature of at least 80° C. During relaxation, the high-pressure treated plant seed base product will then heat up to temperatures above 140° C. and will thereby be sterilized.

In addition to the embodiments shown in FIGS. 6 and 7 for extending the shelf-life of the plant seed base product and within the scope of the invention, the plant seed base product can additionally or alternatively be subjected to a sterilization that is carried out in a heat exchanger or by direct steam injection, for example.

### Exemplary Embodiment 1

A mixture made up of oat flour and water was used, with a dry mass content of 15 wt. %. Oat flour usually has a residual moisture content of not more than 12 wt. %. The flour used in this example had a residual moisture content of approx. 9 wt %. Prior to the ultra-high pressure treatment, comminution was carried out using a Turrax (IKA® Process-Pilot 2000/04) operated in-line at 12800 rpm at a back pressure of 1 bar. Samples ultra-high pressure-treated at treatment pressures of 1000, 2000, 3000, and 4000 bar were examined.

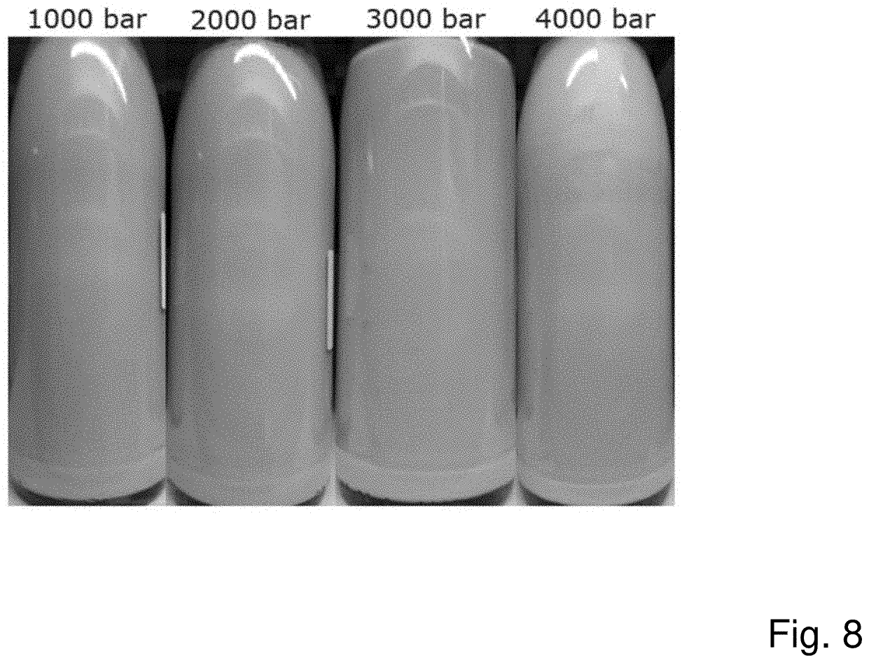

It was found that for this dry mass content, the best results were achieved at values between 2000 and 3000 bar. FIG. 8 shows photographs of the samples. A visually smooth structure was observed for all samples. An ultra-high pressure treatment at 4000 bar resulted in a product in which a significantly lighter-colored phase formed in the upper portion of the sample compared to the rest of the material in the sample.

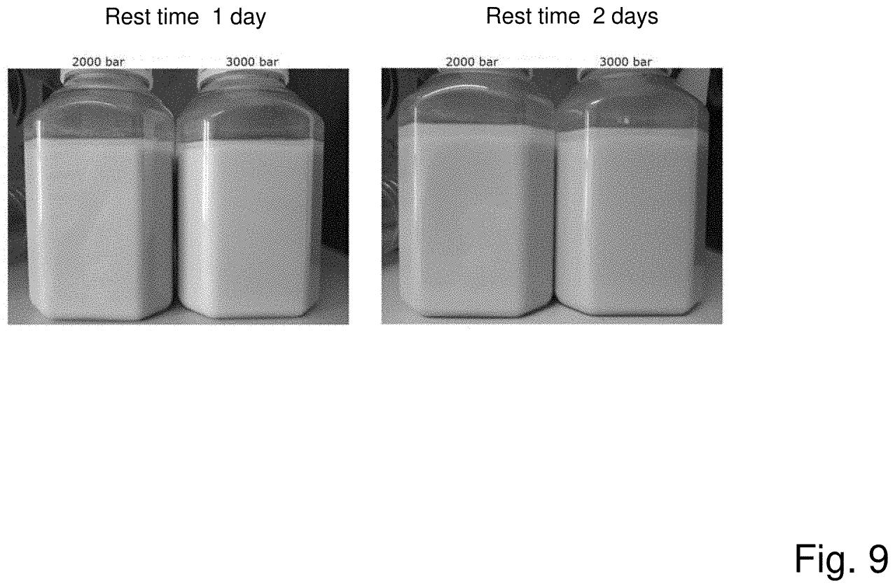

The photographs in FIG. 9 show that, over a refrigerated short-term storage at a temperature between 4° C. and 8° C. for one or two days, only slight sedimentation occurred, which can be rectified by manually shaking the sample.

Tastings of the samples revealed that at pressures above 1000 bar a structure with a smooth mouthfeel was produced. In the case of the samples produced at 2000 bar, some roughness was noticeable on the tongue, and the samples produced at 3000 bar did not show this roughness, but had a thinner texture than the samples produced at 2000 bar.

After a stability test by centrifugation at 4000 g for 10 minutes, the samples prepared at 2000 bar and 3000 bar showed less phase separation than the samples prepared at 1000 bar and 4000 bar.

The following table summarizes the results of particle size analysis (Malvern Panalytical, Mastersizer 3000; refractive index disperse phase: 1.449; refractive index dispersant: 1.330; light shading: 10-15%), which were performed on the materials that had been treated at the specified pressures. Here, the light shading value is a measure for the dilution, which cannot be converted into SI units. However, this specification will be sufficient for a person skilled in the art to comprehend and trace the measurement with this device and software. Given below are the parameters d_{3.97}, d_{3.50}, and d_{3.10}, in micrometers, of the volume density distribution of the particles.

| | Parameter | | |
|---|---|---|---|
| | d_{3.97} | d_{3.50} | d_{3.10} |
| 1000 bar | 176 | 32 | 0.894 |
| 2000 bar | 118 | 28 | 1.12 |
| 3000 bar | 88.7 | 24.2 | 1.76 |
| 4000 bar | 82.9 | 19.6 | 1.86 |

The following results of a viscosity measurement (Anton Paar rheometer MCR 102; measuring body: ST-24; temperature=10° C.) confirm the findings, according to which the range of 2000 bar found for the stated dry mass content of the wholegrain oat material is preferred over the other pressures examined.

| | Viscosity in mPa · s @ shear rate of | | | | |
|---|---|---|---|---|---|
| | 5/s | 11.4/s | 21/s | 49.8/s | 101/s |
| 1000 bar | 242.1 | 172.4 | 91.7 | 59.3 | 49.8 |
| 2000 bar | 441.6 | 311.4 | 163.5 | 101.6 | 77.8 |
| 3000 bar | 156.7 | 123.7 | 78.5 | 57.7 | 50.8 |
| 4000 bar | 138.1 | 106.5 | 67.4 | 49.1 | 43.3 |

A variation of the product described above with a dry mass content of 20 wt. % also resulted in stable products when prepared by an ultra-high pressure treatment at 2000 bar and at 3000 bar.

Furthermore, it was found that lactic acid fermentation of the wholegrain oat base materials according to the invention is possible and led to yoghurt-like products with a sour taste classified as pleasant from a sensory point of view. For products with a texture similar to a milk-based yoghurt, dry mass contents above 20 wt. % should be aimed for when using wholegrain oat flour.

### Exemplary Embodiment 2

A mixture made up of oat flour and water with an oat content of 35 wt. % was used. Oat flour usually has a residual moisture content of not more than 12 wt. %. The flour used in this example had a residual moisture content of approx. 9 wt %.

Prior to the ultra-high pressure treatment, comminution was carried out using a Turrax (IKA® Process-Pilot 2000/04) operated in-line at 12800 rpm at a back pressure of 1 bar, or using a high-pressure homogenizer at 300 bar. No significant differences were found on the product between these two methods of comminution.

Samples ultra-high pressure-treated at treatment pressures of 2000, 2500, and 3000 bar were examined.

The following table summarizes the results of particle size analysis (Malvern Panalytical, Mastersizer 3000; refractive index disperse phase: 1.449; refractive index dispersant: 1.330; light shading: 10-15%), which were performed on the materials that had been treated at the specified pressures. Given below are the parameters d_{3.97}, d_{3.50}, and d_{3.10}, in micrometers, of the volume density distribution of the particles.

| | Parameter | | |
|---|---|---|---|
| | d_{3.97} | d_{3.50} | d_{3.10} |
| 2000 bar | 133 | 23.5 | 1.01 |
| 2500 bar | 113 | 22.6 | 0.899 |
| 3000 bar | 97.3 | 22.5 | 0.952 |

High-pressure homogenization within the scope of the invention, at a pressure above 2000 bar, in particular at 2500 bar or 3000 bar, allows to produce wholegrain oat base products with a dry mass content of 35 wt. % and a smooth texture in the mouthfeel. In terms of taste, the sample produced at 3000 bar was preferred in the sensory evaluation. The highest viscosity and the best mouthfeel among the samples examined was achieved with a pressure of 2500 bar.

The stability of a “ready to drink” product is better with a pressure of 3000 bar than that of a corresponding product that has undergone an ultra-high pressure treatment at 2000 bar. Here, better stability means a lower proportion of supernatant forming in the sample over a storage time of up to 72 hours, for example.

In this example, the samples were subjected to a subsequent sterilization process step at 141° C. for a duration of 4 s and were treated downstream in a two-stage high-pressure homogenizer at 250 bar in the first stage and 50 bar in the second stage. It was found that this subsequent process step narrows the particle size distribution by shifting the d_{3.10} parameter towards larger and the d_{3.97} parameter towards smaller values.

### Exemplary Embodiment 3

The same mixture made up of oat flour and water as in exemplary embodiment 2 was used and the effect of repeated multiple homogenization was examined.

The following table summarizes the results of particle size analysis of these studies. The measurements were performed using the “Mastersizer 3000” from Malvern Panalytical, with the following parameters: refractive index disperse phase: 1.449; refractive index dispersant: 1.330; light shading: 10-15%. Given below are the parameters d_{3.97}, d_{3.50}, and d_{3.10}, in micrometers, of the volume density distribution of the particles.

| | Parameter | | |
|---|---|---|---|
| | d_{3.97} | d_{3.50} | d_{3.10} |
| Number of passes | | | |
| @ 300/50 bar | | | |
| 1 | 423 | 52.1 | 3.25 |
| 2 | 318 | 48.3 | 3.1 |
| 3 | 255 | 47.6 | 3.07 |
| 4 | 223 | 41.6 | 2.92 |
| 5 | 222 | 44.7 | 2.90 |
| 10 | 175 | 38.0 | 2.62 |
| 15 | 154 | 35.7 | 2.58 |
| 17 | 159 | 35.0 | 2.69 |

What was found is that it is impossible with multiple passes through a two-stage high-pressure homogenizer of the APV Gaulin LAB 60/500/2 type at 300/50 bar, to achieve a similar result as with the method according to the invention. The specification “300/50 bar” means that a total pressure of 300 bar is built up. The pressure drops from 300 bar to 50 bar via a first valve. This 50 bar is relieved to ambient pressure via a second valve. In fact, multiple repetition of homogenization at 300/50 bar permits to approximately obtain the particle size of a treatment according to the invention at 1000 bar. The maximum particle size is somewhat higher than with an ultra-high pressure treatment according to the invention at 1000 bar, but the d_{3.97} diameter is significantly higher. Adequate comminution for a pleasantly smooth mouthfeel and a particle size of less than 130 micrometers is only achieved at the higher pressures according to the invention.

Even repeated homogenization at 1000 bar does not achieve the same result as a high-pressure treatment according to the invention at 3000 bar.

| | Parameter | | |
|---|---|---|---|
| | d_{3.97} | d_{3.50} | d_{3.10} |
| Number of passes @ | | | |
| 1000 bar | | | |
| 1 | 199 | 32.2 | 1.77 |
| 2 | 218 | 29.9 | 1.53 |
| 3 | 162 | 26.7 | 1.33 |
| 4 | 136 | 25.1 | 1.22 |
| 5 | 126 | 23.9 | 1.17 |
| 10 | 134 | 24.7 | 1.22 |

### Exemplary Embodiment 4

A mixture made up of wholegrain rice flour and water with a wholegrain rice content of 35 wt. % was used. Wholegrain rice flour has a maximum residual moisture content of 14.5 wt. %. The wholegrain rice flour used in conjunction with this embodiment had a residual moisture content of about 12 wt. %. In comparison to the results obtained with wholegrain oats (exemplary embodiment 2) it was found that the processing of wholegrain rice is similarly possible.

Prior to the ultra-high pressure treatment, comminution was carried out using a “Turrax” (IKA® Process-Pilot 2000/04) operated in-line at 12800 rpm with a back pressure of 1 bar, or using a high-pressure homogenizer at 300 bar. No significant differences were found on the product between these two methods of comminution.

Samples ultra-high pressure treated at treatment pressures of 1000, 2000, 3000, and 4000 bar were examined.

The following table summarizes the results of particle size analysis (Malvern Panalytical, Mastersizer 3000; refractive index disperse phase: 1.449; refractive index dispersant: 1.330; light shading: 10-15%), which were performed on the materials that had been treated at the specified pressures. Given below are the parameters d_{3.97}, d_{3.50}, and d_{3.10}, in micrometers, of the volume density distribution of the particles.

| | Parameter | | |
|---|---|---|---|
| | d_{3.97} | d_{3.50} | d_{3.10} |
| 1000 bar | 134 | 17.0 | 3.40 |
| 2000 bar | 87.1 | 13.5 | 2.72 |
| 3000 bar | 66.4 | 11.9 | 2.19 |
| 4000 bar | 48.9 | 11.2 | 3.85 |

Within the scope of the invention, high-pressure homogenization at a pressure above 2000 bar, in particular at 2500 bar or 3000 bar, allows to prepare wholegrain rice base products with a smooth texture in the mouth. The samples produced under at least 3000 bar exhibited better stability than the other samples. Here, better stability means a lower proportion of supernatant forming in the sample over a storage period.

### Exemplary Embodiment 5

A mixture made up of 6.65 wt. % of golden linseed flour and water was used. Golden linseed flour has a maximum residual moisture content of 10 wt. %. The golden linseed flour used in this embodiment had a residual moisture content of about 9 wt. %.

In comparison to the results obtained with wholegrain oats and wholegrain rice (exemplary embodiments 2 and 3) it was found that the processing of golden linseed flour, i.e. a flour from an oilseed, is likewise possible within the scope of the invention.

The golden linseed flour that was used is flour from press cake after oil extraction, which is finely ground, and which therefore has a lower fat content than the whole seed. The proportion of linseed used was reduced in comparison to the other flours according to the above exemplary embodiments. The mucilage contained in the golden linseed caused comparatively strong thickening of the product and was broken down by cellulases.

Samples ultra-high pressure treated at treatment pressures of 1000, 2000, 3000, and 4000 bar were examined.

The following table summarizes the results of particle size analysis (Malvern Panalytical, Mastersizer 3000), which were performed on the materials that had been treated at the specified pressures. Given below are the parameters d_{3.97}, d_{3.50}, and d_{3.10}, in micrometers, of the volume density distribution of the particles.

| | Parameter | | |
|---|---|---|---|
| | d_{3.97} | d_{3.50} | d_{3.10} |
| 1000 bar | 262 | 29.5 | 3.88 |
| 2000 bar | 123 | 20.1 | 3.05 |
| 3000 bar | 72.6 | 19.9 | 4.60 |
| 4000 bar | 71.2 | 23.6 | 5.03 |

The following results of a viscosity measurement (Anton Paar Rheometer MCR 102; measuring body: ST-24; temperature=10° C.) show that, at pressures of at least 3000 bar, a significantly higher viscosity was obtained than at 1000 or 2000 bar, while the difference between the samples produced at 3000 bar and at 4000 bar is small.

| | Viscosity in mPa · s @ shear rate of | | | | |
|---|---|---|---|---|---|
| | 5/s | 11.4/s | 21/s | 49.8/s | 101/s |
| 1000 bar | 382.6 | 231.6 | 163.4 | 109.2 | 89.3 |
| 2000 bar | 702.8 | 398.3 | 268.1 | 164 | 120.8 |
| 3000 bar | 1617.9 | 876.2 | 565.3 | 318.2 | 207.5 |
| 4000 bar | 1525.2 | 831.4 | 548 | 315.5 | 205.5 |

After a stability test by centrifugation at 4000 g for 10 minutes, the samples prepared at 1000 bar and 2000 bar show less phase separation and more homogeneous sediments than the samples prepared at 3000 bar and 4000 bar.

It will be apparent to a person skilled in the art that the invention is not limited to the examples described above, but can rather be varied in many ways. More particularly, the features of the individually illustrated examples can also be combined with one another or exchanged for one another.

1.-16. (canceled)

17. A method for producing a plant seed base product, without removing any components of the seeds used, comprising the steps of:
a) soaking plant seed feedstock in water, the plant seed feedstock comprising at least seeds selected from the group consisting of cereals, pseudocereals, other plant seeds, and mixtures of these seeds;
b1) liquefying the mixture from step a) under the action of enzymes to produce a liquefied plant seed feedstock; and
b) high-pressure homogenizing the liquefied plant seed feedstock at a pressure of at least 800 bar.

18. The method of claim 17,
wherein step a) is preceded by a step
a1) of adding at least one enzyme.

19. The method of claim 18,
wherein the at least one enzyme comprises one or more of amylase, lipase, β-glucanase, protease, and cellulase.

20. The method as claimed in claim 17,
wherein at least one of the enzymes has a hydrolytic activity of at least 5% towards dietary fibers.

21. The method as claimed in claim 17,
wherein step b) is preceded by a step
b2) of deactivating at least one enzyme.

22. The method of claim 21,
wherein the deactivating of at least one enzyme is achieved by heating and by altering a pH value.

23. The method of claim 21,
wherein the deactivating is performed at temperatures in a range between 120° C. and 150° C. over a duration of up to 5 minutes.

24. The method of claim 21,
wherein the deactivating is performed at temperatures at a maximum temperature of 95° C. over a duration of up to one hour.

25. The method as claimed in claim 22,
wherein prior to the heating, the pH value is adjusted in the range from 3 to 5.

26. The method as claimed in claim 22,
wherein following the heating the pH value is adjusted in the range from 6 to 8.

27. The method as claimed in claim 17,
wherein step b) is preceded by a step
b11) of comminuting the plant seed feedstock; and/or by a step
b111) of comminuting the liquefied plant seed feedstock.

28. The method as claimed in claim 17,
wherein step b) is followed by a step
c) of keeping hot the high-pressure treated plant seed base product at a temperature in the range from 65° C. to 95° C.

29. The method as claimed in claim 17,
wherein step b) comprises high-pressure homogenization of the liquefied plant seed feedstock at a pressure of at least 2000 bar.

30. A plant seed base product produced by the method according to claim 17,
wherein the plant seed base product comprises all components of the at least one used plant seed or their degradation products, respectively, and
wherein a volume density distribution of particles of the plant seed base product in which d3.97 is not more than 130 micrometers.

31. The plant seed base product of claim 30,
wherein a percentage of plant seeds in the plant seed base product is up to 50 wt. %.

32. The plant seed base product as claimed in claim 30,
wherein the plant seed base product comprises at least one seed selected from the group consisting of cereals, pseudocereals, oilseeds and legume seeds, and mixtures of these seeds.

33. A foodstuff or an additive to a foodstuff comprising the plant seed base product as claimed in claim 30, wherein the foodstuff is selected from the group consisting of alternatives to milk and milk products, beverages, drinking milk, milkshakes, drinking yoghurt, yoghurt, and ice cream preparations.
